(19) United States
(12) Patent Application Publication
(10) Pub. No.: US 2025/0047418 A1
(43) Pub. Date: Feb. 6, 2025

(54) METHOD AND APPARATUS OF HARQ FEEDBACK FOR VARIABLE CODE RATE RETRANSMISSION

(71) Applicant: HUAWEI TECHNOLOGIES CO., LTD., Shenzhen (CN)

(72) Inventors: Yu CAO, Kanata (CA); Ming JIA, Kanata (CA); Huazi ZHANG, Kanata (CA); Jianglei MA, Kanata (CA)

(21) Appl. No.: 18/926,586

(22) Filed: Oct. 25, 2024

Related U.S. Application Data
(63) Continuation of application No. PCT/CN2022/089252, filed on Apr. 26, 2022.

(51) Int. Cl. H04L 1/1607; H04L 1/00

(52) U.S. Cl. CPC H04L 1/1671; H04L 1/0009; H04L 1/0026

(57) ABSTRACT

Methods and apparatuses for providing feedback in a HARQ scheme are described. A transmission-specific channel quality indicator (CQI) feedback scheme is described. A channel coding-related feedback scheme is also described.

### CROSS-REFERENCE TO RELATED APPLICATION

This application is a continuation of International Application No. PCT/CN2022/089252, filed on Apr. 26, 2022, the disclosure of which is hereby incorporated by reference in its entirety.

### TECHNICAL FIELD

The present disclosure relates to methods and apparatuses for wireless communications based on a HARQ feedback scheme.

### BACKGROUND

Hybrid automatic repeat request (HARQ) is a common technique used in wireless communication to improve the likelihood of successfully transmitting and receiving a message. The message is encoded with an error correction scheme so that some number of errors introduced by the wireless channel can be corrected at the receiver without further action from the transmitter. If the receiver cannot decode the message, it will send HARQ feedback to the transmitter, causing the transmitter to retransmit the message.

Improvements over the commonly-used HARQ schemes have been developed. For example, a cross-code block coding-based approach may be used to generate the retransmitted message. In an example implementation, the retransmission is a message generated from at least parts of multiple different code blocks (CBs), which may result in more efficient use of network resources for example. A retransmission scheme that makes use of cross-code block coding techniques may be referred to as a cross-CB HARQ scheme, or a two-dimensional (2D) HARQ scheme.

Further improvements to HARQ retransmission are generally desirable. For example, solutions that help to improve the nature or content of the retransmission and/or help to reduce the amount of resources used for retransmission are generally desirable.

### SUMMARY

In various examples, the present disclosure describes methods and apparatuses for wireless communications using a retransmission scheme. In particular, a feedback scheme is described, which enables the transmitter node to determine an amount of redundancy to be used for a retransmission.

In some examples, the feedback scheme may be based on an instantaneous channel quality indicator (CQI), which is measured based on the initial transmission.

Additionally, a cross-CB coded transmission scheme based on the new feedback is also described. In addition, the new feedback scheme is extended to multicast and network coding scenarios.

In an example aspect, the present disclosure describes a method at a receiver node, the method including: receiving a data transmission from a transmitter node, the data transmission including transmission of an associated reference signal; determining, from the reference signal, a transmission-specific channel quality indicator (CQI) associated with the received data transmission; and transmitting feedback to the transmitter node indicating the transmission-specific CQI.

In an example of the preceding example aspect of the method, the reference signal may be a demodulation reference signal (DMRS).

In an example of any of the preceding example aspects of the method, the data transmission may include one or more code blocks, and the method may further include performing a decoding operation to decode the one or more code blocks. The method may further include one of: in response to successful decoding of the one or more code blocks, the feedback indicating the transmission-specific CQI represents a positive acknowledgement (ACK) indicating decoding was successful; or in response to unsuccessful decoding of at least one of the one or more code blocks, the feedback indicating the transmission-specific CQI represents a negative acknowledgement (NACK) indicating decoding was not successful.

In an example of any of the preceding example aspects of the method, the feedback indicating the transmission-specific CQI may be transmitted separately from acknowledgement feedback.

In an example of any of the preceding example aspects of the method, the transmission-specific CQI may indicate a highest supported modulation and coding scheme (MCS) that can be supported by a current channel quality measured from the reference signal, and that provides a block error rate (BLER) below a defined threshold.

In an example of the preceding example aspect of the method, the transmission-specific CQI may be determined by: identifying, from a defined CQI table, a CQI index value corresponding to the highest supported MCS, wherein the identified CQI index value is used as the transmission-specific CQI.

In an example of the preceding example aspect of the method, a reserved CQI index value of the defined CQI table may be defined to indicate ACK.

In an example of any of the preceding example aspects of the method, determining the transmission-specific CQI may include: determining a differential CQI that represents a difference in channel quality between a current channel quality measured from the reference signal of the received data transmission and a previously reported channel quality, wherein the differential CQI is used as the transmission-specific CQI.

In an example of the preceding example aspect of the method, the differential CQI may be indicated as a difference between a first MCS used for the received data transmission, the first MCS being based on the previously reported channel quality, and a second MCS that is a highest supported MCS that can be supported by the current channel quality.

In an example of any of the preceding example aspects of the method, the data transmission may be a retransmission comprising one or more retransmitted code blocks or one or more cross-block check blocks generated from bits selected from across one or more code blocks of the data transmission.

In an example of any of the preceding example aspects of the method, the method may further include: subsequent to transmitting the feedback to the transmitter node, receiving a retransmission from the transmitter node, wherein the retransmission uses at least one retransmission parameter different from a corresponding parameter used for the data transmission.

In another example aspect, the present disclosure describes a method at a transmitter node, the method including: sending a data transmission to a receiver node, the data transmission including one or more code blocks and transmission of an associated reference signal; receiving, from the receiver node, feedback indicating a transmission-specific channel quality indicator (CQI) associated with the received data transmission; and sending a retransmission to the receiver node, using retransmission parameters determined based on the received feedback.

In an example of the preceding example aspect of the method, the reference signal may be a demodulation reference signal (DMRS).

In an example of any of the preceding example aspects of the method, the feedback indicating the transmission-specific CQI may represent a negative acknowledgement (NACK) indicating decoding of the one or more code blocks at the receiver node was not successful.

In an example of any of the preceding example aspects of the method, the feedback indicating the transmission-specific CQI may be transmitted separately from NACK feedback.

In an example of any of the preceding example aspects of the method, the method may further include determining at least one retransmission parameter, and the at least one retransmission parameter may be one of: a retransmission rate; a modulation and coding scheme (MCS); a power level; a beamforming parameter; a number of retransmitted code blocks; or a number of check blocks.

In an example of any of the preceding example aspects of the method, the transmission-specific CQI may correspond to a suggested retransmission rate, and wherein the retransmission is performed using the suggested retransmission rate.

In an example of any of the preceding example aspects of the method, the retransmission may include one or more retransmitted code blocks or one or more cross-block check blocks generated from bits selected from across the one or more code blocks of the data transmission.

In another example aspect, the present disclosure describes a method at a receiver node, the method including: receiving a data transmission of one or more code blocks from a transmitter node; performing a decoding operation to decode the one or more code blocks; determining channel coding-related feedback based on the decoding operation; and transmitting the channel coding-related feedback to the transmitter node.

In an example of the preceding example aspect of the method, the channel coding-related feedback may be determined based on hard decision output, from a decoder at the receiver node, generated from the decoding operation.

In another example of the preceding example aspect of the method, the channel coding-related feedback may be determined based on soft output, from a decoder at the receiver node, generated from the decoding operation.

In another example of the preceding example aspect of the method, the channel coding-related feedback may be determined based on decoding convergence behaviour of a decoder at the receiver node during the decoding operation.

In another example aspect, the present disclosure describes an apparatus including: a processing unit; and a non-transitory memory including instructions that, when executed by the processing unit, cause the apparatus to perform any one of the preceding example aspects of the method.

In another example aspect, the present disclosure describes a non-transitory computer readable medium having machine-executable instructions stored thereon, wherein the instructions, when executed by a processing unit of an apparatus, cause the apparatus to perform any one of the preceding example aspects of the method.

### BRIEF DESCRIPTION OF THE DRAWINGS

Reference will now be made, by way of example, to the accompanying drawings which show example embodiments of the present application, and in which:

FIG. 1 is a schematic diagram illustrating an example wireless communication system suitable for implementing examples described herein;

FIG. 2 is a block diagram illustrating an example apparatus suitable for implementing examples described herein;

FIGS. 3A-3C illustrate example code structures from which cross-block check blocks may be generated;

FIGS. 4A and 4B are signaling diagrams illustrating examples of how CSI reporting is performed;

FIG. 5 is a flowchart illustrating an example method for providing transmission-specific CQI feedback, in accordance with examples of the present disclosure;

FIG. 6 is a signaling diagram illustrating an example implementation of the method of FIG. 5;

FIG. 7 shows an example CQI table, which may be used to implement examples of the present disclosure;

FIG. 8 show an example table of feedback indexes, which may be used to implement examples of the present disclosure;

FIG. 9 is a flowchart illustrating an example method for providing channel coding-related feedback, in accordance with examples of the present disclosure;

FIG. 10 is a signaling diagram illustrating an example implementation of the method of FIG. 9; and

FIG. 11 is a flowchart illustrating an example method that may be performed by a transmitter node, in accordance with examples of the present disclosure.

Similar reference numerals may have been used in different figures to denote similar components.

### DETAILED DESCRIPTION

To assist in understanding the present disclosure, an example wireless communication system is first described.

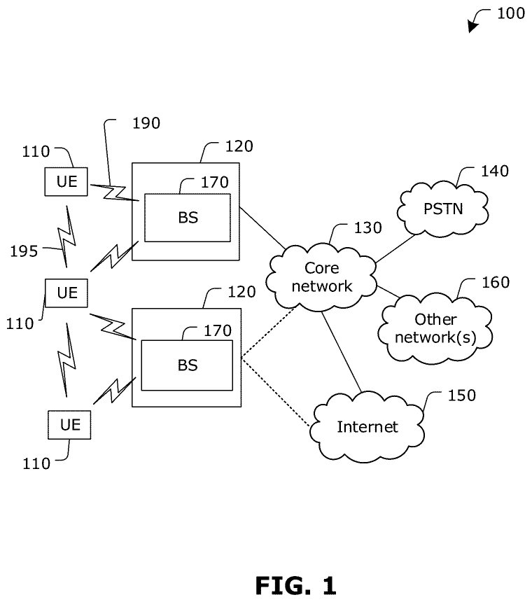

FIG. 1 illustrates an example wireless communication system 100 (also referred to as a wireless system 100) in which embodiments of the present disclosure could be implemented. In general, the wireless system 100 enables multiple wireless or wired elements to communicate data and other content. The wireless system 100 may enable content (e.g., voice, data, video, text, etc.) to be communicated (e.g., via broadcast, narrowcast, user device to user device, etc.) among entities of the system 100. The wireless system 100 may operate by sharing resources such as bandwidth. The wireless system 100 may be suitable for wireless communications using 5G technology and/or later generation wireless technology. In some examples, the wireless system 100 may also accommodate some legacy wireless technology (e.g., 3G or 4G wireless technology).

In the example shown, the wireless system 100 includes user equipment (UEs) 110, radio access networks (RANs) 120, a core network 130, a public switched telephone network (PSTN) 140, the internet 150, and other networks 160. In some examples, one or more of the networks may be omitted or replaced by a different type of network. Other networks may be included in the wireless system 100. Although certain numbers of these components or elements are shown in FIG. 1, any reasonable number of these components or elements may be included in the wireless system 100.

The UEs 110 are configured to operate, communicate, or both, in the wireless system 100. For example, the UEs 110 may be configured to transmit, receive, or both via wireless or wired communication channels. The term “UE” may be used to refer to any suitable end user device for wireless operation and may include such devices (or may be referred to) as a wireless transmit/receive unit (WTRU), a mobile station, a mobile relay, a fixed or mobile subscriber unit, a cellular telephone, a station (STA), a machine type communication (MTC) device, a personal digital assistant (PDA), a smartphone, a laptop, a computer, a tablet, a wireless sensor, an internet of things (IoT) device, a network-enabled vehicle, or a consumer electronics device, among other possibilities. In some examples, the term electronic device (ED) may be used instead of UE. In general, it should be understood that the use of the term UE in the present disclosure does not necessarily limit the present disclosure to any specific wireless technology.

In FIG. 1, the RANs 120 include base stations (BSs) 170. Although FIG. 1 shows each RAN 120 including a single respective BS 170, it should be understood that any given RAN 120 may include more than one BS 170, and any given RAN 120 may also include base station controller(s) (BSC), radio network controller(s) (RNC), relay nodes, elements, and/or devices. Each BS 170 is configured to wirelessly interface with one or more of the UEs 110 to enable access to any other BS 170, the core network 130, the PSTN 140, the internet 150, and/or the other networks 160. For example, the BSs 170 may also be referred to as (or include) a base transceiver station (BTS), a radio base station, a Node-B (NodeB), an evolved NodeB (eNodeB or eNB), a Home cNodeB, a gNodeB (gNB) (sometimes called a next-generation Node B), a transmission point (TP), a transmission and reception point (TRP), a site controller, an access point (AP), or a wireless router, among other possibilities. Future generation BSs 170 may be referred to using other terms. In some examples, the term TRP may be used to encompass a BS 170 or any other node that may serve to transmit and receive communications. Thus, although the present disclosure makes references to BSs 170, it should be understood that this is not intended to be limiting. Any UE 110 may be alternatively or additionally configured to interface, access, or communicate with any other BS 170, the internet 150, the core network 130, the PSTN 140, the other networks 160, or any combination of the preceding. In some examples, a BS 170 may access the core network 130 via the internet 150.

The UEs 110 and BSs 170 are examples of communication equipment that can be used to implement some or all of the functionality and/or embodiments described herein. Any BS 170 may be a single element, as shown, or multiple elements, distributed in the corresponding RAN 120, or otherwise. Each BS 170 transmits and/or receives wireless signals within a particular geographic region or area, sometimes referred to as a “cell” or “coverage area”. A cell may be further divided into cell sectors, and a BS 170 may, for example, employ multiple transceivers to provide service to multiple sectors. In some embodiments there may be established pico or femto cells where the radio access technology supports such. A macro cell may encompass one or more smaller cells. The number of RANs 120 shown is exemplary only. Any number of RANs may be contemplated when devising the wireless system 100.

The BSs 170 communicate with one or more of the UEs 110 over one or more uplink (UL)/downlink (DL) wireless interfaces 190 (e.g., via radio frequency (RF), microwave, infrared, etc.). The UL/DL interface 190 may also be referred to as a UL/DL connection, UE-BS link/connection/interface, or UE-network link/connection/interface, for example. The UEs 110 may also communicate directly with one another (i.e., without involving the BS 170) via one or more sidelink (SL) wireless interfaces 195. The SL interface 195 may also be referred to as a SL connection, UE-to-UE link/connection/interface, vehicle-to-vehicle (V2V) link/connection/interface, vehicle-to-everything (V2X) link/connection/interface, vehicle-to-infrastructure (V2I) link/connection/interface, vehicle-to-pedestrian (V2P) link/connection/interface, device-to-device (D2D) link/connection/interface, or simply as SL, for example. The wireless interfaces 190, 195 may utilize any suitable radio access technology. For example, the wireless system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) for wireless communications.

The RANs 120 are in communication with the core network 130 to provide the UEs 110 with various services such as voice, data, and other services. The RANs 120 and/or the core network 130 may be in direct or indirect communication with one or more other RANs (not shown), which may or may not be directly served by core network 130, and may or may not employ the same radio access technology. The core network 130 may also serve as a gateway access between (i) the RANs 120 or UEs 110 or both, and (ii) other networks (such as the PSTN 140, the internet 150, and the other networks 160). In addition, some or all of the UEs 110 may include functionality for communicating with different wireless networks over different wireless links using different wireless technologies and/or protocols. Instead of wireless communication (or in addition thereto), the UEs 110 may communicate via wired communication channels to a service provider or switch (not shown), and to the internet 150. PSTN 140 may include circuit switched telephone networks for providing plain old telephone service (POTS). The internet 150 may include a network of computers and subnets (intranets) or both, and incorporate protocols, such as Internet Protocol (IP), Transmission Control Protocol (TCP), User Datagram Protocol (UDP). The UEs 110 may be multimode devices capable of operation according to multiple radio access technologies, and incorporate multiple transceivers necessary to support such.

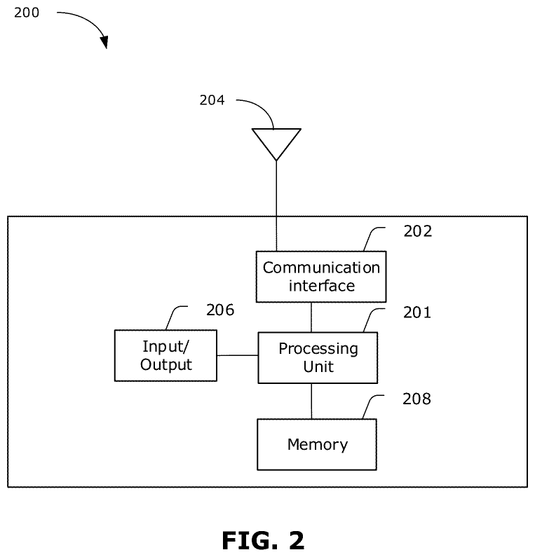

FIG. 2 illustrates an example apparatus 200 that may implement examples disclosed herein. FIG. 2 illustrates a possible embodiment for the UE 110 or the BS 170, and is not intended to be limiting.

As shown in FIG. 2, an example apparatus 200 (e.g., an example embodiment of the UE 110 or BS 170) includes at least one processing unit 201. The processing unit 201 implements various processing operations of the apparatus 200. For example, the processing unit 201 could perform signal coding, data processing, power control, input/output processing, or any other functionality of the apparatus 200. The processing unit 201 may also be configured to implement some or all of the functionality and/or embodiments described in more detail herein. Each processing unit 201 includes any suitable processing or computing device configured to perform one or more operations. Each processing unit 201 could, for example, include a microprocessor, microcontroller, digital signal processor, field programmable gate array, or application specific integrated circuit.

The apparatus 200 includes at least one communication interface 202 for wired and/or wireless communications. One or multiple communication interfaces 202 could be used in the apparatus 200. Each communication interface 202 includes any suitable structure for generating signals for wireless or wired transmission and/or processing signals received wirelessly or by wire. Although shown as a single functional unit, the communication interface 202 could also be implemented using at least one transmitter interface and at least one separate receiver interface. In some examples, one or more transmitters and one or more receivers may be implemented by the communication interface 202.

The apparatus 200 includes one or more antennas 204 for wireless communications. Each antenna 204 includes any suitable structure for transmitting and/or receiving wireless signals. In some examples, the apparatus 200 may include multiple antennas 204 to support multiple-input multiple-output (MIMO) communications. There may be multiple antennas 204 that together form an antenna array, which may be used for beamforming and beam steering operations. In some examples, there may be one or more antennas 204 used for transmitting signals and separate one or more antennas 204 used for receiving signals.

The apparatus 200 further includes one or more input/output devices 206 or input/output interfaces (such as a wired interface to the internet 150). The input/output device(s) 206 permit interaction with a user or other devices in the wireless system 100. Each input/output device 206 includes any suitable structure for providing information to or receiving information from a user, such as a speaker, microphone, keypad, keyboard, display, or touchscreen, including network interface communications.

In addition, the apparatus 200 includes at least one memory 208. The memory 208 stores instructions and data used, generated, or collected by the apparatus 200. For example, the memory 208 could store software instructions or modules configured to implement some or all of the functionality and/or embodiments described herein and that are executed by the processing unit(s) 201. Each memory 208 includes any suitable volatile and/or non-volatile storage and retrieval device(s). Any suitable type of non-transitory memory may be used, such as random access memory (RAM), read only memory (ROM), hard disk, optical disc, subscriber identity module (SIM) card, memory stick, secure digital (SD) memory card, and the like.

Hybrid automatic repeat request (HARQ) is a commonly used retransmission technique. Conventional HARQ retransmission schemes are typically based on whether a transport block (TB) was successfully decoded by a receiver node. If the receiver node was unsuccessful in decoding even one code block (CB) of a packet (where a packet may be a single TB), then negative feedback is sent back to the transmitter node and the transmitter node performs a retransmission of the entire packet, even if other CBs of the packet were successfully decoded by the receiver node. This may be an inefficient use of communication resources. In New Radio (NR) Release 15, code block group (CBG) based HARQ retransmission is supported. In CBG based HARQ retransmission, CBs are grouped in CBGs, and feedback from the receiver node includes the index of the CBG containing the CB that was not successfully decoded. Then the retransmission can be based on only the CBG having the index indicated in the feedback. However, CBG based HARQ retransmission requires the feedback to include the CBG index that needs to be retransmitted, which increases the overhead of the HARQ feedback. Further, in the case where each CGB has one (or more) CB in error, all CBGs (i.e., the entire TB) are used for the retransmission thus there would be no savings in retransmission, in addition to the added overhead of having to feedback the CBG indexes. As such, CBG based HARQ still may result in inefficiencies.

Retransmission schemes based on the use of cross-block check blocks (also referred to as cross-packet check blocks or vertical check blocks) have been described. For example, techniques for generating cross-block check blocks have been described in U.S. patent application Ser. No. 16/665,121, entitled “SYSTEM AND METHOD FOR HYBRID-ARQ”, filed Oct. 28, 2019, the entirety of which is hereby incorporated by reference. The use of cross-block check blocks in network coding (also referred to as 2D network coding or 2D joint network coding) has been described in U.S. patent application Ser. No. 17/110,226, entitled “METHODS AND SYSTEMS FOR NETWORK CODING USING CROSS-PACKET CHECK BLOCKS”, filed Dec. 2, 2020, the entirety of which is hereby incorporated by reference.

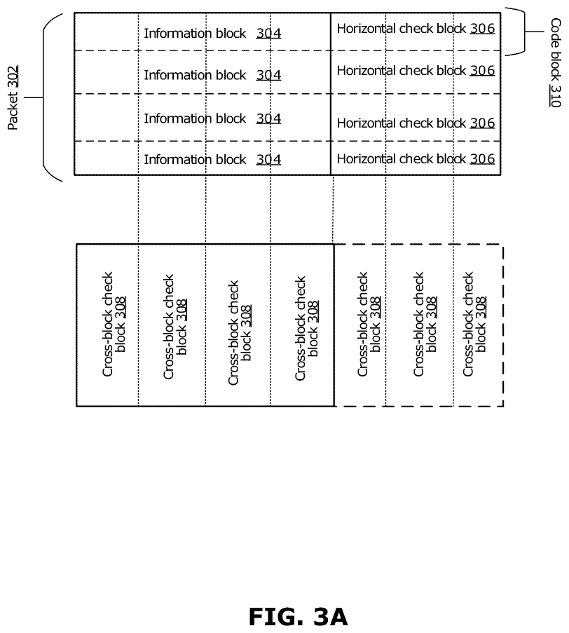

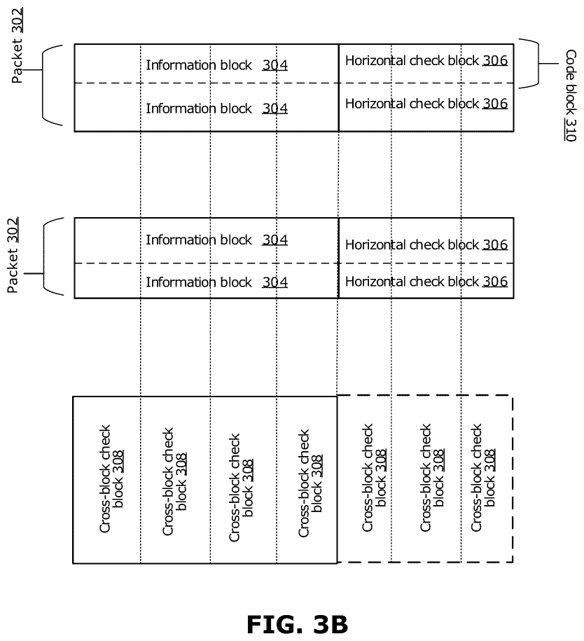

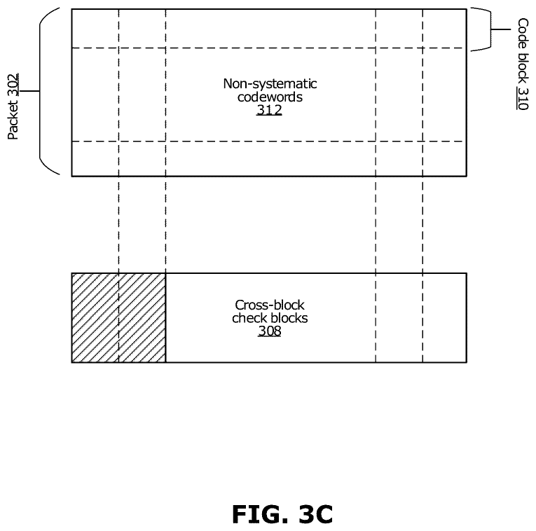

Examples of how cross-block check blocks may be generated are now described with reference to FIGS. 3A-3C.

FIG. 3A illustrates an example code structure for a single packet 302 (which may be one TB) that is segmented into multiple CBs 310 (in this example, four CBs 310 are shown for simplicity, however this is not intended to be limiting). Each CB 310 includes an information block 304 formed from encoder input bits. The encoder input bits may also be referred to as information bits. Each CB 310 also includes check bits (e.g., cyclic redundancy check (CRC) bits) generated using the bits from the information block 304 of the CB 310. The check bits, which are appended to the information block 304 of the CB 310, may be referred to as a horizontal check block 306. As shown, there may be one horizontal check block 306 in each CB 310. The term “horizontal” refers to how the check bits in the horizontal check block 306 are generated using only the information bits from a single CB 310, and is not intended to imply any physical structure or orientation. A horizontal check block 306 may also be referred to as an intra-block check block or a single-CB check block, among other possibilities.

One or more cross-block check blocks 308 are generated using bits selected from across two or more CBs 310. In some examples, cross-block check blocks 308 may be referred to as vertical check blocks (to distinguish from the horizontal check blocks 306), however the term “vertical” is not intended to imply any physical structure or orientation. Further, it should be understood that the terms “parity block” or “redundancy block” may also be used instead of “check block”. In FIG. 3A, each cross-block check block 308 is generated using bits selected from across two or more CBs 310 of the packet 304.

FIG. 3B illustrates another example, which is similar to that of FIG. 3A with the difference that FIG. 3B illustrates two different packets 302 and the cross-block check blocks 308 are generated using bits selected from across the CBs of the two different packets 302. Although two packets 302 are shown, it should be understood that there may be more packets 302. Thus, FIG. 3B illustrates an example in which each cross-block check block 308 is generated using bits selected from across the CBs 310 of two or more packets 302. In this example, the cross-block check blocks 308 may also be referred to as cross-packet check blocks (because the cross-block check blocks 308 are generated using bits selected from across two or more packets 302).

FIG. 3C illustrates another example, which illustrates how cross-block check blocks 308 may be generated from non-systematic code (e.g., Polar code, block code, or convolutional code). The packet 302 is segmented into a plurality of CBs 310, where each CB 310 is a non-systematic codeword 312. Each non-systematic codeword is determined based on a set of encoder input bits, but the information bits do not appear in the codeword as systematic bits. Unlike systematic codes, horizontal check bits are not simply appended to a set of information bits. In this example, a single packet 302 is shown however it should be understood that there may be more than one packet 302 (each packet 302 containing CBs 310 with non-systematic codewords 312). In this example, each cross-block check block 308 is generated using bits selected from cross two or more CBs 310.

It will be appreciated by persons skilled in the art that the present disclosure is not dependent on whether systematic or non-systematic code is used. For simplicity, the following discussion may be based packets 302 having systematic CBs 310. It should be understood that this is not intended to be limiting.

When systematic CBs 310 are used, the cross-block check blocks 308 may include one or more cross-block check blocks 308 generated from bits selected across multiple information blocks 304. Optionally, one or more cross-block check blocks 308 may also be generated using bits selected from across multiple horizontal check blocks 306. Cross-block check blocks 308 generated from bits selected from horizontal check blocks may be referred to as “check on check” blocks.

In general, in each of the examples of FIGS. 3A-3C, each cross-block check block 308 is generated from bits selected across multiple CBs 310. In particular, one or more bits may be selected from each of two or more CBs 310. The selected bits may be referred to as cross-block bits (because the bits are selected from across multiple CBs 310), and the group of selected bits may be referred to as the cross-block information block. The cross-block information block is then encoded (e.g., using a FEC code, such as LDPC code) or otherwise combined (e.g., using XOR, linear combination, etc.) to obtain the cross-block check block 308. In general, the term check block should be understood to encompass various techniques that may be used to combine bits selected from across different CBs 310, including using XOR or using a linear combination of bits as well as encoding techniques such as encoding the selected bits using a channel code (among other possibilities).

When CBs 310 are arranged in rows, as shown in FIGS. 3A-3C, each cross-block check block 308 may be generated from a column of bits, where the column of bits may have any suitable width (e.g., may be one or more bits wide). Different cross-block check blocks 308 may be generated from columns of different bit widths (i.e., different cross-block check blocks 308 may be generated using different numbers of cross-block bits). In some examples, each CB 310 may be divided into equal (or approximately equal) number of bits, referred to as subblocks. Then each cross-block check block 308 may be generated from bits belonging to a respective column of subblocks.

A set of cross-block check blocks 308 may be generated based on the bits of the CBs 310 in their natural order. The natural order of the bits may refer to the order of bits in each CB 310 as outputted by the encoder. A different set of cross-block check blocks 308 may be generated by shuffling (or interleaving) the bits within each CB 310 (such that the vertical columns of bits that are obtained after the shuffling or interleaving is different from the vertical columns of bits that are obtained when the bits of the CBs 310 are in their natural order). A predefined shuffling scheme or predefined interleaver may be used to perform this shuffling or interleaver. An interleaver may be a predefined algorithm or predefined matrix (among other possibilities) that is applied to the row of bits to obtain a reordered row of bits.

It should be understood that other techniques (not necessarily limited to interleaving) may be used. Different sets of cross-block check blocks 308 may be thus generated for the same set of CBs 310, using the bits in their natural order or using different interleavers (e.g., where a different interleaver is associated with each different redundancy version (RV) index). Examples of how each RV index may be associated with a respective interleaver used for generating cross-block check blocks 308 are described in PCT application no. PCT/CN2021/121483, “METHODS AND APPARATUSES FOR WIRELESS COMMUNICATION RETRANSMISSION USING CHECK BLOCKS GENERATED ACCORDING TO SUBBLOCK INTERLEAVERS”, filed Sep. 28, 2021, the entirety of which is hereby incorporated by reference.

The manner in which cross-block bits are selected (e.g., which interleaver or RV index to use, how many bits to select across different CBs 310, which CBs 310 from which to select the cross-block bits, etc.) and the manner in which the cross-block check blocks 308 are generated (e.g., what combination or encoding technique to use, how many cross-block check blocks 308 to generate, whether check-on-check blocks are generated, etc.) may be configured by the transmitter node and/or by a network controller, and/or may be defined by a standard.

The check bits contained in the horizontal check blocks 306 and cross-block check blocks 308 are useful to assist decoding at a receiver node. For example, after each decoding operation (also referred to as a decoding attempt) at a decoder, error checking can be performed using check bits to determine if the information bits in the CB 310 have been successfully decoded. Each cross-block check block 308 contains check bits generated from across multiple CBs 310, and thus provides information useful for decoding multiple CBs 310. The decoder may use the check bits of the cross-block check block 308 to assist in decoding of a CB 310.

In examples where the CBs 310 are systematic (such as LDPC code or Turbo code), an iterative decoding process may be used at the decoder at the receiver node to decode the received CBs 310. The decoder calculates log-likelihood ratios (LLRs) of bit values during decoding of the CBs 310, which may be considered a “soft” output of the decoder. In the present disclosure, soft output may refer to decoder output that is not yet finalized (e.g., bit value not yet definitively determined to be 1 or 0 value) but may provide information that can still be useful (e.g., in a subsequent decoding iteration). Such soft output may be probabilistic in nature (e.g., LLR). CBs 310 that are not correctly decoded (e.g., fails a check using the corresponding horizontal check blocks 306) may benefit from information encoded in the cross-block check blocks 308. Because each of the cross-block check blocks 308 is generated from information bits selected from two or more (or all) of the CBs 310, soft output from decoding operations to decode a cross-block check block 308 may help to improve decoding of the CBs 310 (and vice versa). In at least this way, cross-block check blocks 308 help to improve decoding.

A HARQ retransmission scheme that makes use of cross-block check blocks may be referred to as cross-block HARQ or 2D HARQ. A HARQ retransmission scheme that does not make use of cross-block check blocks may be referred to as conventional HARQ or 1D HARQ. The present disclosure describes an example feedback mechanism, which may be used in both conventional HARQ and cross-block HARQ. The disclosed feedback mechanism may enable a receiver node to provide information to the transmitter node about the quality of an initial transmission, to enable the transmitter node to determine a suitable amount of redundancy (e.g., code rate) to be used for a retransmission (rather than using the same code rate as the initial transmission). This provides the advantage that the retransmission resources required for a retransmission may be reduced while maintaining the overall reliability.

In existing LTE and NR wireless communication systems, channel quality indicator (CQI) feedback is part of channel state information (CSI) feedback. CSI feedback typically includes a rank indicator (RI), precoding matrix indicator (PMI) and CQI, among other information. For a given corresponding indicated rank and precoding matrix, the CQI indicates the maximum modulation and coding scheme (MCS) that the channel quality can support.

CSI feedback, including CQI feedback, is typically transmitted in a CSI report that is sent in a physical uplink control channel (PUCCH) or a physical uplink shared channel (PUSCH). The CSI report can be periodic, semi-persistent or aperiodic. The periodicity of periodic CSI reporting is configured. Semi-persistent CSI reporting is similar to periodic CSI reporting with the addition that the CSI report can be activated and deactivated (e.g., using MAC control element (CE)). Aperiodic CSI reporting means that each CSI report is triggered explicitly (e.g., using downlink control information (DCI) signaling, or MAC CE).

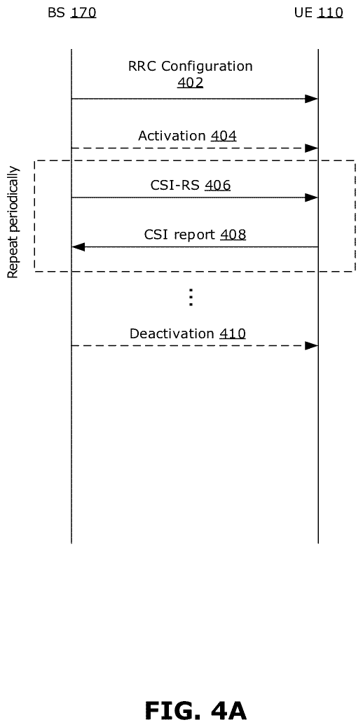

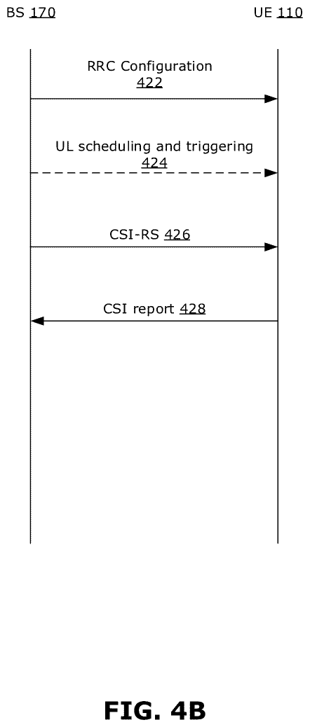

FIG. 4A is a signaling diagram illustrating an example of typical periodic or semi-persistent CSI reporting.

The BS 170 sends a radio resource control (RRC) signal 402 to the UE 110 in order to configure the resources to be used for the CSI report (including the CSI reference signal (CSI-RS)). Optionally, if semi-persistent CSI reporting is being used, the BS 170 may send an activation signal 404 (e.g., using MAC CE) to the UE 110. The BS 170 sends a CSI-RS 406 to the UE 110. The UE 110 uses the CSI-RS to perform a measurement and compute a signal to interference and noise ratio (SINR). The UE 110 determines the highest MCS that the computed SINR would support, and the corresponding CQI index (e.g., using a CQI table, which may be defined in standards). The CQI index is the CQI feedback included in the CSI report 408 that is sent by the UE 110 back to the BS 170. The CSI-RS 406 and the CSI report 408 are repeated periodically. Optionally, if semi-persistent CSI reporting is being used, the periodic CSI report may end after the BS 170 sends a deactivation signal 410 (e.g., using MAC CE) to the UE 110.

FIG. 4B is a signaling diagram illustrating an example of typical aperiodic CSI reporting.

The BS 170 sends a radio resource control (RRC) signal 422 to the UE 110 in order to configure the resources to be used for the CSI report (including the CSI-RS). Optionally, the BS 170 may trigger the aperiodic CSI report in an UL scheduling grant 424. The BS 170 then sends a CSI-RS 426 to the UE 110. The UE 110 uses the CSI-RS to obtain the SINR and reports back the corresponding CQI index in a CSI report 428 (similar to the procedure described above for periodic or semi-persistent CSI reporting). In aperiodic CSI reporting, the CSI-RS 426 and CSI report 428 are not performed again (until the next trigger from the BS 170).

In some examples, instead of using CSI-RS, a synchronization signal block (SSB) may be used instead. Generally, the BS 170 uses the received CQI feedback (included in the CSI report) for link adaptation, meaning that the BS 170 can use the CQI feedback to select the appropriate MCS to be used for transmissions. However, regardless of the specific type of CSI reporting used, there is typically a relatively long time interval (e.g., ˜1 ms) between each CSI report (and hence a relatively long time interval between each CQI feedback). This means that the information contained in the conventional CQI feedback is not necessarily an accurate reflection of rapidly changing channel quality. Further, the conventional CQI measurement is a relatively coarse measurement of channel quality; in particular, the conventional CQI measurement is only made in certain slots and bandwidths (e.g., depending on the CSI-RS or SSB used), which provides information about a channel in general, but not about a specific transmission. In addition, in wireless mobile communications, the channel changes over time. Thus, conventional CQI feedback may not provide an accurate indication of the supported code rate for an actual transmission (e.g., due to interference, channel aging, etc.). In most existing cellular communication applications, the conventional CQI feedback may be considered sufficient for typically slow link adaptation.

In various examples, the present disclosure describes a feedback mechanism that provides information to enable the transmitter node (e.g., a BS) to determine the retransmission rate based on the quality of an initial transmission received at a receiver node. The disclosed transmission-specific CQI feedback may enable faster adaptation of transmission parameters, which may be important in large data volume applications (e.g., involving transmission of larger TBs with many code blocks). The disclosed transmission-specific CQI feedback may enable more efficient use of time/frequency resources while introducing relatively little overhead.

In some examples, the receiver node may provide feedback that is based on dynamic channel measurement performed using the initial transmission. The dynamic channel measurement performed by the receiver node may be a measurement of channel quality, power or energy of the transmitted signal, among other possibilities. An example of channel quality measurement, discussed further below, is CQI feedback based on a measurement performed using the initial transmission. Such CQI feedback may be referred to as transmission-specific CQI feedback, instantaneous CQI feedback, or dynamic CQI feedback (or another similarly suitable name), to distinguish from the conventional slower CQI feedback.

In another example, the receiver node may provide feedback that is based on the decoding operation that was performed to decode the initial transmission. Such feedback may be referred to as decoding-based feedback.

In another example, the receiver node may provide feedback that is based on an estimate of the retransmission rate/resources that would be required to successfully decode the initial transmission. The estimate of the retransmission rate/resources required (which may be quantized for a defined number of bits or a defined number of possible selections) may be based on the dynamic channel measurement and/or decoding operation.

In the present disclosure, transmission-specific CQI feedback refers to CQI feedback that may be determined from a reference signal included in a transmission (e.g., an initial transmission). The transmission-specific CQI feedback may be used to indicate the highest MCS that can be supported by the current channel while maintaining the BLER below a given threshold. For example, as discussed in greater detail further below, the transmission-specific CQI feedback may be determined using a CQI table (which may be an existing CQI table that is used for conventional CQI feedback). In other examples, the transmission-specific CQI feedback may be determined using a CQI table that is specific to transmission-specific CQI feedback.

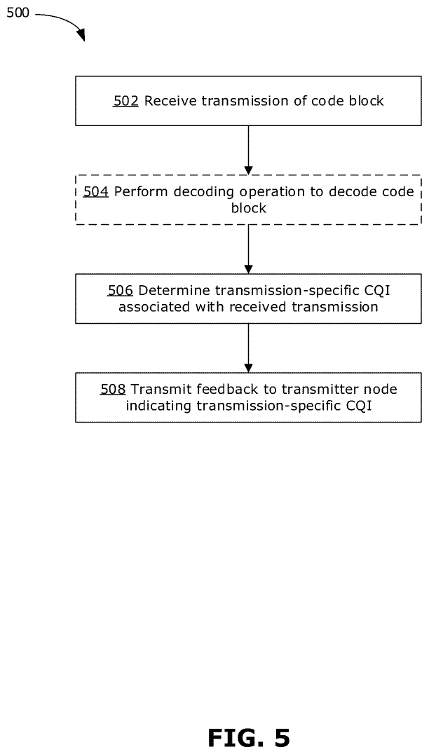

FIG. 5 is a flowchart illustrating an example method 500, which may be performed by an apparatus 200 (e.g., a UE 110) that is a receiver node, to provide transmission-specific CQI feedback back to the transmitter node (e.g., a BS 170).

At 502, a transmission (and more specifically, a data transmission) of one or more CBs is received from a transmitter node. For example, the transmission may be an initial transmission, and the CBs correspond to a data packet from the transmitter node or a transport block transmitted by the transmitter node. The data transmission includes transmission of an associated reference signal, for example a demodulation reference signal (DMRS).

Optionally, at 504, a decoding operation (also referred to as a decoding attempt) to decode the one or more CBs is performed. If decoding is successful (i.e., all received CBs are decoded), the receiver node may provide a positive acknowledgement (ACK) as feedback to the transmitter node instead of transmission-specific CQI feedback. As will be discussed further below, in some examples a reserved CQI index value may be used for transmission-specific CQI feedback to indicate ACK (i.e., ACK feedback may be incorporated into the transmission-specific CQI feedback). In some examples, the transmission-specific CQI feedback (aside from a reserved CQI index value indicating ACK) may be interpreted as a form of negative acknowledgement (NACK) to indicate that decoding of at least one CB was not successful.

In some examples, the transmission-specific CQI feedback may be provided independently of the decoding operation. That is, the transmission-specific CQI feedback may be feedback that is provided separately from ACK/NACK feedback regardless of whether decoding of the received code block was successful or unsuccessful. In that regard, the method 500 may omit the step 504. That is, a decoding operation may be performed at any time but steps 506 and 508 may not be dependent on the results of the decoding operation; further, steps 506 and 508 may be performed prior to or in parallel with the decoding operation. As such, the method 500 may be performed without performing any decoding of the at least one code block.

At 506, a transmission-specific CQI is determined for the received transmission, using the reference signal (e.g., DMRS) included in the transmission. For example, the transmission-specific CQI indicates the highest MCS (e.g., determined from a CQI table) that the channel can support that has a BLER below a given threshold, as further discussed in more detail later in the disclosure. To determine the transmission-specific CQI, the receiver node may obtain a SINR using the reference signal, then determine the CQI value based on the SINR. Existing techniques that are used for determining the conventional slower CQI may be adapted for determining the transmission-specific CQI, as disclosed herein.

At 508, feedback is transmitted to the transmitter node indicating the transmission-specific CQI. The feedback may be provided as ACK/NACK feedback, or may be provided separately from ACK/NACK feedback (e.g., in a separate or dedicated feedback channel).

The transmitter node (e.g., the BS 170) may use the transmission-specific CQI feedback to determine how the retransmission should be performed, for example the transmitter node may determine the code rate, the number of cross-block check blocks (if cross-block check blocks are used), the MCS, a power level, beamforming, etc. to use for the retransmission, based on the transmission-specific CQI feedback. The transmitter node may perform the retransmission using a set of one or more cross-block check blocks, as described above. In other examples, the transmitter node may perform the retransmission using conventional HARQ schemes (i.e., without generating cross-block check blocks).

The receiver node may, subsequent to the transmitter node determining the retransmission parameters using the transmission-specific CQI feedback, receive a retransmission from the transmitter node. Since the transmitter node can use the transmission-specific CQI feedback to adapt the retransmission parameters immediately, the retransmission may use different parameters (e.g., different MCS, different time frequency resource, etc.) than that of the initial transmission. For example, if the initial transmission used a particular MCS, the transmitter node may adapt the retransmission parameters to use a different MCS for the retransmission. Thus, the transmission-specific CQI enables dynamic or instantaneous adaptation of retransmission parameters, which may be more responsive to changing channel conditions compared to conventional, slower CQI feedback.

It should be understood that the method 500 may be similarly performed by the receiver node to provide transmission-specific CQI feedback in response to a retransmission (i.e., the transmission-specific CQI feedback is not necessarily limited to an initial transmission). For example, if the receiver node is still unable to decode all the CBs after a retransmission from the transmitter node, the receiver node may determine the transmission-specific CQI and transmit the transmission-specific CQI feedback back to the transmitter node as a form of NACK (or in addition to a separate NACK feedback) to indicate that decoding still was not successful. The transmitter node may then use the transmission-specific CQI feedback to determine how a second retransmission should be performed. The method 500 may be performed until all of the CBs in the initial transmission have been successfully decoded by the receiver node or until a maximum number of retransmissions have been performed by the transmitter node, for example.

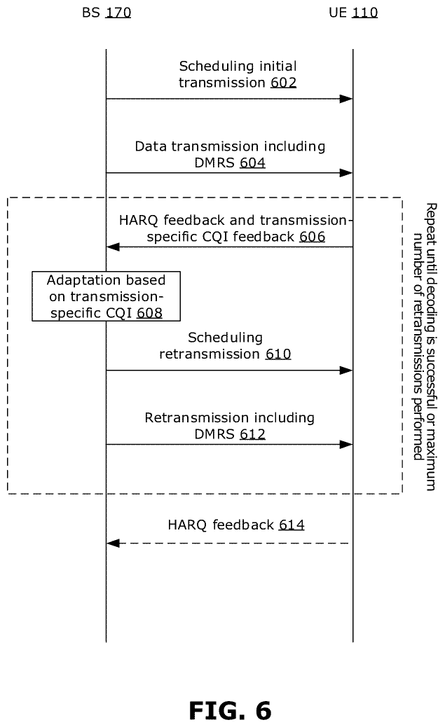

FIG. 6 is a signaling diagram illustrating an example of transmission-specific CQI feedback, for example by implementing an embodiment of the method 500 at the receiver node. In this example, the transmitter node is a BS 170 and the receiver node is a UE 110 (i.e., downlink transmission), however it should be understood that this is not intended to be limiting. For example, in other examples the transmitter node may be a UE 110 and the receiver node may be a BS 170 (i.e., uplink transmission); in other examples the transmitter node may be a first UE 110 and the receiver node may be a second UE 110 (i.e., sidelink transmission).

The BS 170 sends scheduling 602 for an initial transmission to the UE 110. For example, the DL scheduling for the initial transmission may be sent in a DCI signal. The BS 170 then performs a downlink data transmission 604 (i.e., the initial transmission, including one or more CBs) to the UE 110. In particular, the transmission includes the reference signal such as a DMRS. The UE 110 receives the transmission and performs a decoding operation to decode the one or more CBs in the initial transmission (e.g., as described in steps 502 and 504 of the method 500). In this example, at least one code block is not successfully decoded and the UE 110 sends back HARQ feedback (e.g., NACK feedback) and transmission-specific CQI feedback 606. In particular, the UE 110 may determine the transmission-specific CQI feedback using the DMRS from the initial transmission and may send the transmission-specific CQI feedback to the BS 170 together with (or in place of) the HARQ feedback (e.g., as described in steps 506 and 508 of the method 500) over PUCCH.

At 608, the BS 170 is able to use the information in the transmission-specific CQI feedback to adapt transmission parameters (e.g., the code rate, the number of cross-block check blocks (if cross-block check blocks are used), the MCS, power level, beamforming, etc.) for performing a retransmission. The BS 170 schedules the retransmission 610 (e.g., by sending another DCI signal), and performs the downlink retransmission including the DMRS 612. In particular, the retransmission is performed using transmission parameters that have been adapted based on the transmission-specific CQI feedback from the UE 110. The UE 110 then performs decoding again, using the additional information from the retransmission. If decoding is still unsuccessful, the UE 110 may send back transmission-specific CQI feedback with (or in place of) NACK feedback, and the BS 170 may perform another retransmission (with adaptation of transmission parameters in accordance with the transmission-specific CQI feedback). This process may repeat until decoding of all code blocks at the UE 110 is successful or until a maximum number of retransmission(s) is reached. Assuming that decoding of all the code blocks is successful (after one or more retransmissions), the UE 110 may optionally send back HARQ feedback 614 (e.g., ACK feedback) to the BS 170.

It may be appreciated, from the above discussion and examples, that transmission-specific CQI feedback (also referred to as dynamic CQI feedback or instantaneous CQI feedback) as disclosed herein differ from conventional CQI feedback in a number of ways. For example, compared to conventional CQI feedback, there is no need to configure the reference signal resource to be used for CQI reporting, rather the transmission-specific CQI feedback makes use of existing configuration and scheduling of the DMRS resource (which is already used alongside data transmission for channel estimation purposes). The transmission-specific CQI feedback may not need to be explicitly triggered (e.g., unlike the case for semi-persistent or aperiodic CSI reporting), rather the transmission-specific CQI feedback may be transmitted at the same time as existing HARQ feedback (e.g., the receiver node may always send transmission-specific CQI feedback by default) on PUCCH. However, in some examples, signaling (e.g., a scheduling DCI) can include an indicator to indicate to the receiver node whether transmission-specific CQI feedback should be provided for the scheduled data transmission.

Further, conventional CQI feedback in a CSI report is based on a reference signal of a specific bandwidth (e.g., wideband or subband) and resources, and is not associated with any specific transmission. However, transmission-specific CQI feedback as disclosed herein is specifically based on measurements obtained from a specific actual transmission (e.g., the DMRS associated with the data transmission). Thus, compared to conventional CQI feedback, the transmission-specific CQI feedback disclosed herein is a more accurate estimate of channel quality experienced by the receiver node, based on the actual received transmission. The transmission-specific CQI feedback can therefore more accurately predict the code rate supported by the current channel and the amount of retransmission resources needed to successfully decode a transmitted code block.

For example, in the case where an initial transmission includes multiple code blocks and the transmitter node will use cross-block check blocks in a retransmission, the overall code rate supported by the current channel, as indicated by the transmission-specific CQI feedback, may provide a good estimate of how much additional redundancy is required in a retransmission (and hence how many cross-block check blocks to generate). In another example, if the transmitter node is a BS 170, information from the transmission-specific CQI feedback may be used for link adaptation (e.g., to determine MCS to use for a retransmission). In addition, the transmitter node (e.g., BS 170) may adjust the time/frequency resources used for the retransmission, thus helping to reduce the retransmission overhead and/or to improve spectrum efficiency. It should be understood that the transmitter node (e.g., BS 170) may use information from transmission-specific CQI feedback to adjust any other parameter for any subsequent transmission. For example, the BS 170 may adjust power control parameters based on the transmission-specific CQI feedback, or the BS 170 may determine, based on the transmission-specific CQI feedback, that the required redundancy in a retransmission is low such that new data can be transmitted along with the retransmission.

As mentioned above, in some examples the transmission-specific CQI may be determined based on a measurement of SINR using a reference signal, such as the DMRS in the transmission. In other examples, information about a measured power or energy level (e.g. reference signal received power (RSRP), received signal strength indicator (RSSI), L1-RSRP, etc.) may be provided in addition to the transmission-specific CQI feedback. The power or energy measurement may be performed using a reference signal that is not necessarily part of the transmission (i.e., not necessarily using the DMRS in the transmission). For example, the power or energy measurement may be performed using a most recent reference signal (e.g. CSI-RS, SSB, etc.) that is not necessarily part of a transmission. It should be noted that measurements performed using reference signals that are not part of a transmission may result in measurements that less accurately reflect current channel conditions than measurements performed using the DMRS that is sent as part of an actual transmission.

In the examples described above, the transmission-specific CQI feedback may be sent together with HARQ feedback (e.g., ACK/NCK feedback) or may be sent in a separate or dedicated feedback channel. For example, if the transmission-specific CQI feedback is feedback that is based on a downlink transmission (e.g., from the BS 170 to the UE 110 as shown in FIG. 6), the transmission-specific CQI feedback can be sent along with HARQ feedback as part of uplink control information (UCI) on PUCCH. In some examples, a conventional ACK feedback may be incorporated into the transmission-specific CQI feedback. That is, a specific CQI index value in the transmission-specific CQI feedback (e.g., a CQI index value that represents the best channel quality) may be used to indicate ACK, while all other CQI index values represent NACK (as well as providing additional information about the channel quality). In some examples, the transmission-specific CQI feedback may be sent in PUSCH (e.g., possibly along with other uplink data transmission) or in a separate dedicated feedback channel.

In a similar manner, if the transmission-specific CQI feedback is feedback that is based on an uplink transmission (e.g., from the UE 110 to the BS 170), the transmission-specific CQI feedback may be sent in a DCI in a physical downlink control channel (PDCCH) or in a dedicated uplink feedback channel (e.g., similar to a physical channel hybrid ARQ indicator channel (PHICH)). If the transmission-specific CQI feedback is feedback that is based on a sidelink transmission (e.g., between two UEs 110), then the transmission-specific CQI can be sent along with HARQ feedback on a sidelink feedback channel (e.g. on a physical sidelink feedback channel (PSFCH)) or sent separately from HARQ feedback in a separate sidelink feedback channel.

Quantization of the transmission-specific CQI feedback may be performed. Quantization may be useful to reduce the overhead introduced by the transmission-specific CQI feedback, in order to use feedback resources more efficiently. In addition, quantization may reduce the number of possible CQI index values used for transmission-specific CQI feedback to fit within a predefined number of bits (e.g., based on available feedback resources). Some example methods for quantization of the transmission-specific CQI feedback are now discussed. However, it should be understood that various different quantization methods known in the art may be used within the scope of the present disclosure.

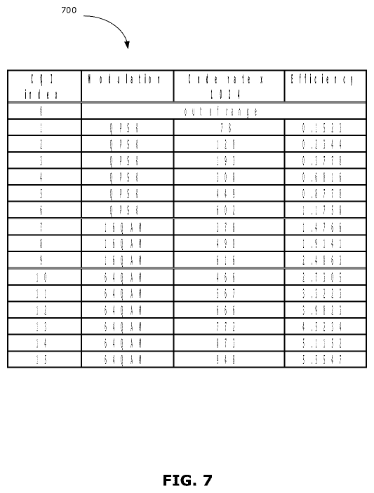

In some examples, the transmission-specific CQI feedback may make use of an existing CQI table (e.g., as discussed below with respect to FIG. 7) that is already used for conventional CQI feedback. Although it may be convenient to adapt the use of CQI index from an existing CQI table for the transmission-specific CQI feedback, it should be understood that this the transmission-specific CQI feedback may be sent in other ways. For example, the transmission-specific CQI feedback may be sent as a measurement of channel quality (e.g., post-processing SINR value), the maximum supported rate, the maximum supported MCS, etc. The transmission-specific CQI feedback may be quantized in various ways to fit the number of choices or bits that are used represent the feedback.

In some examples, the transmission-specific CQI feedback may be dependent on some other parameters, such as the rank and precoder matrix used for MIMO transmission (similar to conventional CSI reporting). However, parameters such as RI or PMI may not need to be reported together with the transmission-specific CQI feedback. Instead, the transmission-specific CQI feedback may be understood to be based on the actual rank and precoder matrix used for the data transmission from which the transmission-specific CQI feedback is determined.

In an example, the transmission-specific CQI feedback may be quantized based on the existing MCS table, similar to how conventional CQI feedback is used for link adaptation.

FIG. 7 shows an example CQI table 700, which is defined in the existing standard: 3GPP TS 38.214 Table 5.2.2.1-2:4-bit CQI table.

As shown in FIG. 7, the CQI table 700 defines 16 possible CQI index values (from 0 to 15) that each correspond to a respective modulation (quadrature phase shift keying (QPSK), 16-point quadrature amplitude modulation (16QAM), or 64-point QAM (64QAM)), approximate supported code rate and spectral efficiency (the number of information bits per symbol). A supported code rate means that a transmission using the MCS corresponding to the CQI index value (and at the corresponding transmission resource) can provide a block error rate (BLER) below a given threshold (e.g., set to be 0.1 in this example). It should be noted that there are different CQI tables that have been defined in standards. Further, the CQI tables used for reporting CQI is usually different from the MCS tables used for scheduling, because the CQI index table usually has fewer MCS entries than the MCS table used for scheduling the actual transmission.

The CQI table 700 (or other existing CQI table) may be adapted for use with the transmission-specific CQI feedback disclosed herein. To further reduce feedback overhead, the number of bits required for indicating the CQI index value may be further reduced (e.g., by reducing the number of possible CQI index values). In some examples, there may be a different and additional CQI table defined for the transmission-specific CQI feedback (rather than using an existing CQI table such as the CQI table 700). For example, a CQI table that is defined for the transmission-specific CQI feedback may have fewer MCS entries compared to existing CQI tables, which correspond to fewer number of bits needed for transmitting the transmission-specific CQI feedback. Such a CQI table may be predefined (e.g. defined in the standard and preprogramed for the network and UEs 110) or signaled to the UE 110 by the network (e.g. via RRC signaling or DCI signaling).

In an example, the transmission-specific CQI feedback may indicate a differential CQI (or delta-CQI), which is the difference in channel quality between the currently measured channel quality and a previously reported channel quality. The previously reported channel quality may be indicated by a previous transmission-specific CQI feedback or indicated by conventional CQI feedback in a most recent CSI report. For example, if the transmission-specific CQI feedback makes use of the same CQI table as a previous conventional CQI feedback in a most recent CSI report, then the transmission-specific CQI feedback can indicate the differential CQI as the difference in supported MCS (e.g., as the difference between the highest supported MCS that can be supported by the currently measured channel quality and the actual MCS that was used for the received transmission). For example, if the previous conventional CQI feedback indicates a first CQI index (representing a first supported MCS) from the CQI table, then the differential CQI may be indicated as a difference between a second CQI index (representing a second supported MCS) and the first CQI index, where the second CQI index is determined using the DMRS from a transmission. In another example, the differential CQI may be indicated as the difference between the currently used MCS (e.g., the MCS used for a current transmission) and the MCS supported by the current channel quality (i.e., determined using the DMRS from the current transmission). For example, the currently used MCS may correspond to a CQI index in the CQI table (or may be rounded to the nearest MCS that is in the CQI table), then the differential CQI may be the difference in between the CQI index of the currently used MCS and the CQI index determined from the DMRS of the current transmission.

In some examples, the transmission-specific CQI feedback may be quantized by directly quantizing the determined CQI value (e.g., the post-processing SINR value). In another example, the transmission-specific CQI feedback may be quantized based on the supported retransmission rate, which may enable the transmitter node to more directly select the rate to use for a retransmission (although, in general, it may be up to the transmitter node or BS 170 to determine how to use the information contained in the transmission-specific CQI feedback).

If an existing CQI table is used for the transmission-specific CQI feedback, the receiver node (e.g., the UE 110) performs operations to determine the transmission-specific CQI feedback by measuring and computing the SINR using the DMRS from a received transmission. Then, from the SINR, the receiver node determines the highest supported MCS, identifies the corresponding CQI index value from the CQI table, and transmits back the identified CQI index value as the transmission-specific CQI feedback. As previously mentioned, in some examples one of the possible CQI index values (e.g., the CQI index corresponding to the highest channel quality) may be reserved to indicate ACK feedback.

There are different techniques that may be used by the receiver node to measure and compute the SINR. An example of how a receiver node may measure and compute the SINR, for determining the transmission-specific CQI feedback, is now described.

For example, the receiver node may perform channel estimation using a pilot (e.g., the DMRS in a received transmission). Then post-processing SNIR estimation is performed, and finally the effective SINR may be estimated (e.g., using exponential effective SINR mapping (EESM) or capacity effective SINR mapping (ESM) similar to that used for PHY abstraction). An equation for effective SINR (SINR_{eff}) estimation (which is commonly used in PHY abstraction) is provided below:

$${SINR}_{eff} = - β ln ( \frac{1}{N} {\sum }_{n - 1}^{N} exp ( - \frac{{SINR}_{n}}{β} ) )$$

where N is the number of subcarriers, SINRₙ is the post-processing SINR at the n-th subcarrier, and β is a tuning factor. β may be tuned based on the MCS or code length, may be predefined, or may be empirically tuned using experimental data, for example.

The receiver node may then use the computed effective SINR to check against the reference BLER curve for each MCS in the CQI table, in order to determine the highest supported MCS that still has a BLER below the set threshold (e.g. 0.1). Having determined the highest supported MCS, the corresponding CQI index may be identified from the CQI table and the receiver node may then feedback the identified CQI index as the transmission-specific CQI feedback.

In another example, the transmission-specific CQI feedback may indicate the maximum supported rate. The receiver node may perform supported rate estimation (e.g., using the well-known Shannon's channel capacity formula which may be expressed as R=BW log₂(1+SINR), where R is the supported rate, BW is the bandwidth, and SINR is the equivalent SINR as described above) or by looking up the reference curve on the target BLER to find the corresponding MCS). The estimated supported rate may be further adjusted based on modulation and other parameters. Then the receiver node may compare the estimated supported rate with the actual transmission rate (based on the received transmission) to estimate the required transmission rate for the retransmission. The estimated required transmission rate may then be indicated in the transmission-specific CQI feedback.

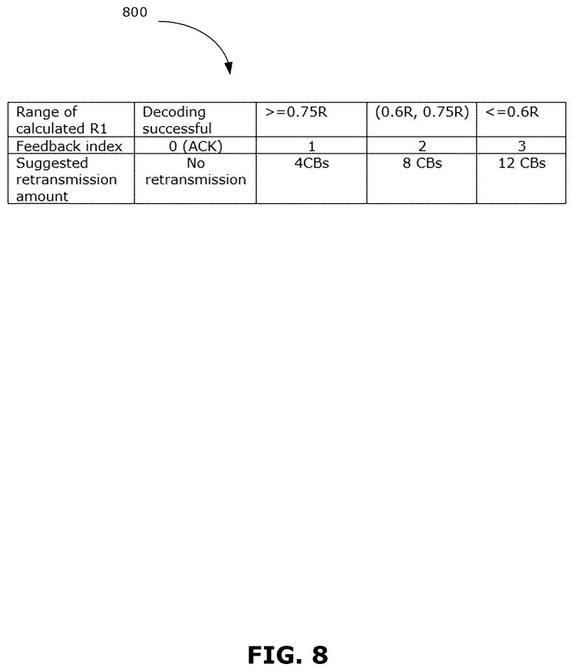

FIG. 8 illustrates an example table 800 of CQI index values that may be used to indicate the estimated required transmission rate.

In this example, it may be assumed that a data transmission is a TB containing 12 CBs, with a given transmission rate (denoted R) and 2-bit feedback is used (corresponding to four possible feedback index values). The feedback index may be based on the range of the estimated supported rate (denoted R1), which is determined based on CQI measurement (e.g., as described above). To help understand the example table 800, the column labeled “>=0.75R” is discussed. The notation >=0.75R indicates that, the estimated supported rate (R1) in the first transmission is greater than or equal to 0.75R (i.e., ¾ of the actual transmission rate (R)). In such a case, this means that retransmission of ⅓ the amount of the original data transmission should support an additional rate of 1/3*0.75R=0.25R. Thus, when the receiver node jointly combines the initial transmission of 12CBs with the retransmission amount of 4CBs, the overall supported rate is likely to be higher than 1R (i.e., the actual transmission rate), which means the receiver node is likely to be able to successfully decode the data after the first retransmission. The entries under the column labeled “(0.6R, 0.75R)” (i.e., estimated supported rate (R1) greater than 0.6 and less than 0.75 of the actual transmission rate (R)) and the column labeled “<=0.6R” (i.e., estimated supported rate is less than or equal to 0.6 of the actual transmission rate (R)) may be understood in a similar manner. It may be noted that the CQI index 0 is reserved to indicate successful decoding (i.e., ACK feedback), in which case there may be no retransmission required.

Further, although the example table 800 includes a corresponding suggested retransmission amount (e.g., a suggested number of code blocks or cross-block check blocks to use for a retransmission), it may not be necessary to explicitly include a suggested retransmission amount in the table 800 because the transmitter node may make its own determination of how the transmission-specific CQI feedback is used to adjust the retransmission parameters. For example, consider an initial transmission that is performed using QPSK at 1/3 rate, where the initial transmission is a TB having 12 CBs. If the receiver node sends back a feedback index of 2 (which, according to the example table 800, corresponds to a suggested retransmission amount of 8 code blocks or cross-block check blocks), the transmitter node may perform a retransmission using 8 cross-block check blocks and the same rate as the initial transmission (i.e., using QPSK at 1/3 rate). Alternatively, the transmitter node may select to perform a retransmission using 12 cross-block check blocks and instead use a different rate (e.g., using QPSK at 1/2 rate).

In some examples, the transmission-specific feedback may provide channel coding-related feedback instead of (or in addition to) providing CQI information. The result of channel decoding by the receiver node may provide information about how much additional redundancy is needed in a retransmission in order to obtain successful decoding (after combining information from the initial transmission and the retransmission).

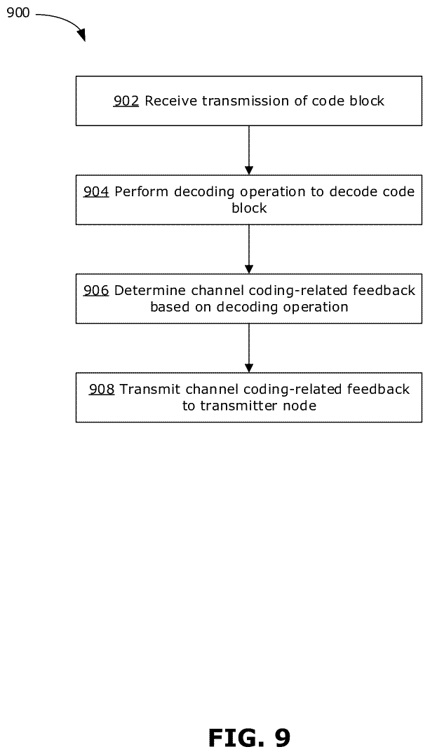

FIG. 9 is a flowchart illustrating an example method 900, which may be performed by an apparatus 200 (e.g., a UE 110) that is a receiver node, to provide channel coding-related feedback back to the transmitter node (e.g., a BS 170).

At 902, a transmission of one or more CBs is received from a transmitter node. For example, the transmission may be an initial transmission, and the CBs correspond to a data packet from the transmitter node. The CB may be coded using systematic code (e.g., LDPC) or non-systematic code (e.g., polar code).

At 904, a decoding operation (also referred to as a decoding attempt) is performed to decode the one or more CBs. If decoding is successful, the receiver node may provide ACK feedback to the transmitter node instead of channel coding-related feedback. In other examples, ACK feedback may be incorporated into channel coding-related feedback (e.g., using a reserved feedback index value), similar to that described above for transmission-specific CQI feedback.

Assuming that decoding of at least one CB was not successful, at 906, the channel coding-related feedback is determined, based on the decoding operation. For example, the channel coding-related feedback may be determined based on the hard decision decoder output, based on the soft output (e.g., LLR) of the decoder, or based on decoding convergence behavior. Details of how channel coding-related feedback may be determined are provided further below.

At 908, the channel coding-related feedback is transmitted to the transmitter node. The feedback may be provided together with ACK/NACK feedback (e.g., in PUCCH or PUSCH, in the case where the transmission is a downlink transmission), or may be provided separately from ACK/NACK feedback (e.g., in a separate dedicated feedback channel).

The transmitter node (e.g., the BS 170) may use the channel coding-related feedback to determine the retransmission rate, for example. For example, if the transmitter node uses cross-block check blocks, as described above, for the retransmission, the transmitter node may use the channel coding-related feedback to determine how many cross-block check blocks and/or which RV to use for the retransmission. However, it should be understood that the transmitter node may use the channel coding-related feedback in other ways to adapt the retransmission. In some examples, the transmitter node may perform the retransmission using conventional HARQ schemes (i.e., without generating cross-block check blocks).

It should be understood that the method 900 may be similarly performed by the receiver node to provide channel coding-related feedback in response to a retransmission. For example, if the receiver node is still unable to decode all the CBs after a retransmission from the transmitter node, the receiver node may determine and transmit back additional channel coding-related feedback, which the transmitter node may to determine how a second retransmission should be performed. The method 900 may be performed until all of the CBs in the initial transmission have been successfully decoded by the receiver node or until a maximum number of retransmissions have been performed by the transmitter node, for example.

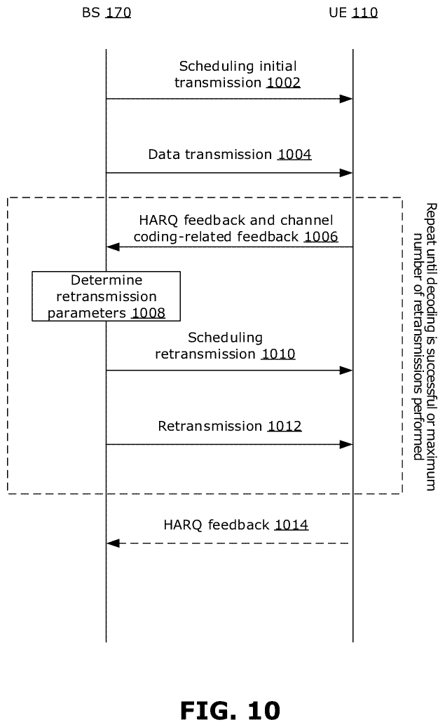

FIG. 10 is a signaling diagram illustrating an example of channel coding-related feedback, for example by implementing an embodiment of the method 900 at the receiver node. In this example, the transmitter node is a BS 170 and the receiver node is a UE 110 (i.e., downlink transmission), however it should be understood that this is not intended to be limiting. For example, the example of FIG. 10 may be adapted for uplink transmission or sidelink transmission.

The BS 170 sends scheduling 1002 for an initial transmission to the UE 110. For example, the DL scheduling for the initial transmission may be sent in a DCI signal. The BS 170 then performs a downlink data transmission 1004 (i.e., the initial transmission, including one or more CBs) to the UE 110. The UE 110 receives the transmission and performs a decoding operation to decode the CBs in the initial transmission. In this example, at least one CB is not successfully decoded and the UE 110 sends back HARQ feedback (e.g., NACK feedback) and channel coding-related feedback 1006.

At 1008, the BS 170 uses the information in the channel coding-related feedback to adapt the parameters for retransmission, such as the transmission rate, the RV, the channel coding method, etc. The BS 170 schedules the retransmission 1010 (e.g., by sending another DCI signal), and performs the downlink retransmission 1012. In particular, the retransmission is performed using the transmission parameters that were determined based on the channel coding-related feedback from the UE 110. The UE 110 then attempts decoding again, using the additional information from the retransmission. If decoding is still unsuccessful, the UE 110 may send back channel coding-related feedback again, and the BS 170 may perform another retransmission (with adaptation of transmission parameters in accordance with the channel coding-related feedback). This process may repeat until decoding of all CBs at the UE 110 is successful or until a maximum number of retransmission(s) is reached. Assuming that decoding of all the CBs is successful (after one or more retransmissions), the UE 110 may optionally send back HARQ feedback 1014 (e.g., ACK feedback) to the BS 170.

It should be understood that various techniques that have been previously described for the transmission-specific CQI feedback may also be adapted for use with the channel coding-related feedback (differing only in that channel coding-related feedback is being transmitted instead of transmission-specific CQI feedback). For example, the techniques for quantization of transmission-specific CQI feedback may be used for quantization of the channel coding-related feedback, so that fewer bits are required to transmit the channel coding-related feedback. In another example, the techniques for transmitting the transmission-specific CQI feedback together with ACK/NACK HARQ feedback or in a separate dedicated feedback channel may also apply to transmission of channel coding-related feedback. In another example, the various ways in which the transmitter node (e.g., the BS 170) may use the transmission-specific CQI feedback to adapt the retransmission parameters may also apply in the case where the transmitter node uses the channel coding-related feedback to adapt retransmission parameters. As the person skilled in the art would readily understand how the previously discussed techniques may be adapted for use with the channel coding-related feedback, the details need not be repeated here.

As mentioned above, the receiver node may determine the channel coding-related feedback in various ways, some of which are now described.

In an example, the channel coding-related feedback may be based on the hard decision decoder output. For example, where the receiver node performs decoding of LDPC or polar codes, the receiver node may use the final decoder output to find the ratio of the number of unpassed check nodes over the total number of check nodes. The details of basic encoding and decoding schemes for LDPC code and polar code are well-known (e.g., LDPC coding is described in Lin et al. Error Control Coding, 2nd edition, Pearson Prentice Hall, Upper Saddle River, 2004) and need not repeated here. For example, consider a LDPC code with a parity check matrix, denoted H, with dimension J×n, where J is the length of the coded bits and n is the length of information bits; and a row vector, denoted z, where z=(z₁, z₂, . . . , zⱼ) represents the binary decision output of the J coded bits. The syndrome of the decoder output may be denoted s, where the syndrome is a vector that provides information about errors in the decoding. Then s=zH^{T} is the syndrome of decoder output z, where s=(s₁, s, . . . , sⱼ) with each sⱼ as one of the J components of s. Then the number of unpassed check nodes are equal to the number of non-zero components of syndrome s, and J is the total number of components of syndrome s. Thus, the ratio of the unpassed check nodes can be computed as the ratio of the number of non-zero component of syndrome s divided by J. The ratio of the unpassed check nodes may be quantized (e.g., defined numerical ranges may be mapped to a defined number of bits) and sent back as feedback.

In another example, the final decoder output may be compared with the hard decision on coded bits from the output signal (after processing and before the input to the decoder) and the ratio of the differences may be quantized and sent back as feedback. In another example, the result of the CRC check of already decoded CBs (or cross-block check blocks, if applicable) may be quantized and sent back as feedback. For example, for an LDPC code transmitted over an additive white Gaussian noise (AWGN) channel, consider a row vector x, of length J, that is the binary hard decision output of the coded bits based on the received signal sequence without going through the channel decoder for the LDPC code, where the received signal sequence is usually used as the input of the channel decoder. Consider also a row vector z, also of length J, that is the final binary decoding output of the LDPC decoder for the coded bits (as described previously). Then, the channel coding-related feedback may be the ratio of the differences, which may be computed as the number of non-zero components in the vector (x-z) divided by the total number of vector components J.

In some examples, the channel coding-related feedback may be based on the soft output (e.g., LLR) of the decoder. For example, a reliability estimate may be computed using the output LLRs and the quantized estimate may be sent back as feedback.

In some examples, the channel coding-related feedback may be based on decoding convergence behavior. For example, the number of decoding iterations until convergence (or non-convergence of decoding operations) may be quantized and provided as feedback. For example, for the output LLRs of information bits of the decoder output, a reliability value can be assigned based on the LLR value. The reliability of all bits in a CB that passes the CRC check can be assigned a reliability value of 1. For the remaining undecoded CBs, the assigned reliability value may be based on a comparison of the absolute value of the LLR with a defined threshold, denoted Th. If the absolute value of the LLR is larger than the given threshold Th, then the reliability value can be assigned to be a value of 1; if the LLR is equal to 0, the reliability value can be assigned to be a value 0; if the absolute value of the LLR is between 0 and Th, then the reliability value can be computed using a defined reliability function (e.g., r=f(LLR)) that assigns the reliability value to be a quantization of the LLR that is in the range between 0 and 1 (the reliability function may be defined such that the larger the absolute value of LLR, the larger the reliability value (but always below 1)). Then the overall reliability that is transmitted as the channel coding-related feedback can be estimated as the sum of all the reliability values of all information bits together, divided by the total number of information bits. The reliability function and/or the threshold Th may be defined empirically (e.g., from experiment data, and calculated or based on output of multiple iterations/convergence behavior).

In examples where quantization is used, the quantized value may be an index value that is mapped to a defined numerical range, accorded to a standard-defined table (e.g., similar to how CQI index values are mapped using defined CQI tables).

It may be noted that the channel coding-related feedback may be used to help the transmitter node to determine various retransmission parameters, such as the retransmission rate, the channel coding scheme, the RV index or other parameters. For example, the transmitter node may use the channel coding-related feedback to help determine which coded bits to use for the retransmission (e.g., which RV index to use for the retransmission). In an example, if the channel coding-related feedback indicates poor decoding results for an initial transmission (e.g., indicates a majority of the CBs could not be decoded), the transmitter node may determine that the retransmission should be performed with RV index 0 (i.e., the same as the initial transmission; and RV index 0 usually contains more information bits than other RV index). On the other hand, if the channel coding-related feedback indicates a good decoding result (e.g., successfully decoding most but not all the CBs in the initial transmission), the transmitter node may determine that the retransmission should be performed with RV index 1 or 2 instead, which may contain fewer information bits and provide incremental redundancy.

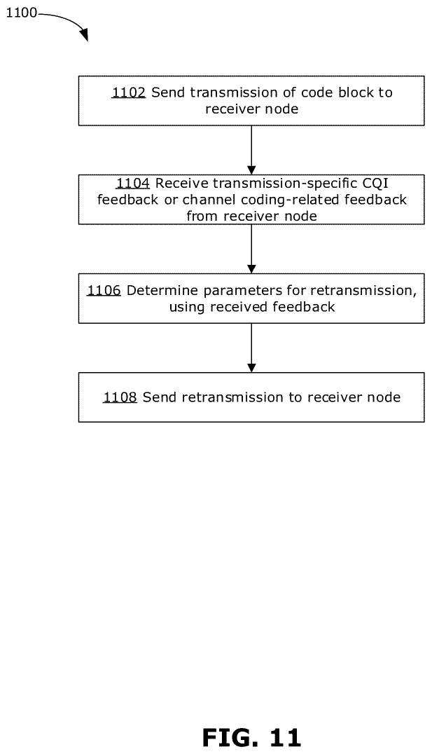

FIG. 11 is a flowchart illustrating an example method 1100 which may be performed by an apparatus 200 (e.g., a BS 170) that is a transmitter node. The method 1100 may be performed in the context of transmission-specific CQI feedback or channel coding-related feedback being sent back by the receiver node (e.g., a UE 110). For example, the method 1100 may be performed by the BS 170 in the examples of FIG. 6 or FIG. 10.

At 1102, the transmitter node sends a transmission of one or more CBs to the receiver node. For example, the transmission may be an initial transmission, and the CBs correspond to a data packet. The transmission includes a reference signal, for example a DMRS.

At 1104, transmission-specific CQI feedback or channel coding-related feedback is received from the receiver node, for example as described previously. The feedback may be received as ACK/NACK feedback (e.g., in PUCCH or PUSCH), or may be provided separately from ACK/NACK feedback (e.g., in a separate feedback channel). If ACK feedback is received, the method 1100 may end. If the feedback indicates that retransmission is required, the method 1100 proceeds to step 1106.

At 1106, the transmitter node uses the feedback (e.g., the transmission-specific CQI feedback or the channel coding-related feedback) to determine the parameters for performing a retransmission. For example, the transmitter node may determine the code rate, the number of cross-block check blocks (if cross-block check blocks are used), the MCS, power level, beamforming, etc. to use for the retransmission. If the feedback indicates a recommended or suggested retransmission rate, for example, the transmitter node may use the recommended or suggested retransmission rate for the retransmission. In some examples, the transmitter node may choose to ignore the recommended or suggested retransmission rate and determine its own retransmission parameters.

At 1108, a retransmission is sent to the receiver node, using the parameters determined at step 1106. The transmitter node may perform the retransmission using a set of one or more cross-block check blocks, as described above. In other examples, the transmitter node may perform the retransmission using conventional HARQ schemes (i.e., without generating cross-block check blocks).

It should be understood that the steps 1104-1108 may be repeated to perform multiple retransmissions. For example, the transmitter node may continue to receive feedback from the receiver node and perform retransmission using parameters determined based on the feedback, until all of the CBs in the initial transmission have been successfully decoded by the receiver node (e.g., ACK is received from the receiver node) or until a maximum number of retransmissions have been performed by the transmitter node.

Although examples have been described in the context of unicast transmission (i.e., transmitter node transmits to one receiver node), it should be understood that the present disclosure may also be used for groupcast or multicast applications. For example, for a groupcast or multicast transmission, each receiver node may determine and send back its own transmission-specific CQI feedback (or channel coding-related feedback). The transmitter node may use the worst-case feedback (i.e., the transmission-specific CQI feedback (or channel coding-related feedback) indicating the worst channel quality (or most unsuccessful decoding attempt) among all the receiver nodes) as the basis for determining the parameters for a retransmission.

In various examples, the present disclosure has described a feedback scheme that provides transmission-specific (also referred to as dynamic or instantaneous) feedback. In particular, transmission-specific CQI feedback and channel coding-related feedback have been described. Examples of the present disclosure may enable a transmitter node (e.g., a BS) to determine retransmission parameters (e.g., retransmission rate, MCS, power level, beamforming, etc.). The disclosed feedback may be used in retransmission schemes that make use of cross-block check blocks, as well as in retransmission schemes that do not make use of cross-block check blocks.

The present disclosure has described example methods for quantization of the transmission-specific CQI feedback and the channel coding-related feedback, which may help to reduce the related overhead. In some examples, existing methods for providing index-based feedback (e.g., using existing CQI tables) may be adapted for use with the disclosed feedback scheme.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method at a receiver node, comprising:
receiving a data transmission from a transmitter node, the data transmission including transmission of an associated reference signal;
determining, from the reference signal, a transmission-specific channel quality indicator (CQI) associated with the received data transmission; and
transmitting feedback to the transmitter node indicating the transmission-specific CQI.

2. The method of claim 1, wherein the data transmission includes one or more code blocks, the method further comprising performing a decoding operation to decode the one or more code blocks;
the method further comprising one of:
in response to successful decoding of the one or more code blocks, the feedback indicating the transmission-specific CQI represents a positive acknowledgement (ACK) indicating decoding was successful; or
in response to unsuccessful decoding of at least one of the one or more code blocks, the feedback indicating the transmission-specific CQI represents a negative acknowledgement (NACK) indicating decoding was not successful.

3. The method of claim 1, wherein the transmission-specific CQI indicates a highest supported modulation and coding scheme (MCS) that can be supported by a current channel quality measured from the reference signal, and that provides a block error rate (BLER) below a defined threshold.

4. The method of claim 3, wherein the transmission-specific CQI is determined by:
identifying, from a defined CQI table, a CQI index value corresponding to the highest supported MCS, wherein the identified CQI index value is used as the transmission-specific CQI.

5. The method of claim 1, wherein determining the transmission-specific CQI comprises:
determining a differential CQI that represents a difference in channel quality between a current channel quality measured from the reference signal of the received data transmission and a previously reported channel quality, wherein the differential CQI is used as the transmission-specific CQI.

6. The method of claim 1, further comprising:
subsequent to transmitting the feedback to the transmitter node, receiving a retransmission from the transmitter node, wherein the retransmission uses at least one retransmission parameter different from a corresponding parameter used for the data transmission.

7. A method at a transmitter node, comprising:
sending a data transmission to a receiver node, the data transmission including one or more code blocks and transmission of an associated reference signal;
receiving, from the receiver node, feedback indicating a transmission-specific channel quality indicator (CQI) associated with the received data transmission; and
sending a retransmission to the receiver node, using retransmission parameters determined based on the received feedback.

8. The method of claim 7, wherein the feedback indicating the transmission-specific CQI represents a negative acknowledgement (NACK) indicating decoding of the one or more code blocks at the receiver node was not successful.

9. The method of claim 7, further comprising determining at least one retransmission parameter, the at least one retransmission parameter being one of:
a retransmission rate;
a modulation and coding scheme (MCS);
a power level;
a beamforming parameter;
a number of retransmitted code blocks; or
a number of check blocks.

10. The method of claim 7, wherein the transmission-specific CQI corresponds to a suggested retransmission rate, and wherein the retransmission is performed using the suggested retransmission rate.

11. An apparatus comprising:
a processing unit; and
a non-transitory memory including instructions that, when executed by the processing unit, cause the apparatus to:
receive a data transmission from a transmitter node, the data transmission including transmission of an associated reference signal;
determine, from the reference signal, a transmission-specific channel quality indicator (CQI) associated with the received data transmission; and
transmit feedback to the transmitter node indicating the transmission-specific CQI.

12. The apparatus of claim 11, wherein the data transmission includes one or more code blocks, and the instructions further cause the apparatus to:
perform a decoding operation to decode the one or more code blocks; and
in response to successful decoding of the one or more code blocks, the feedback indicating the transmission-specific CQI represents a positive acknowledgement (ACK) indicating decoding was successful; or
in response to unsuccessful decoding of at least one of the one or more code blocks, the feedback indicating the transmission-specific CQI represents a negative acknowledgement (NACK) indicating decoding was not successful.

13. The apparatus of claim 11, wherein the transmission-specific CQI indicates a highest supported modulation and coding scheme (MCS) that can be supported by a current channel quality measured from the reference signal, and that provides a block error rate (BLER) below a defined threshold.

14. The apparatus of claim 11, wherein the transmission-specific CQI is determined by identifying, from a defined CQI table, a CQI index value corresponding to the highest supported MCS, wherein the identified CQI index value is used as the transmission-specific CQI.

15. The apparatus of claim 11, wherein the instructions further cause the apparatus to determine the transmission-specific CQI by determining a differential CQI that represents a difference in channel quality between a current channel quality measured from the reference signal of the received data transmission and a previously reported channel quality, wherein the differential CQI is used as the transmission-specific CQI.

16. The apparatus of claim 11, wherein the instructions further cause the apparatus to, subsequent to transmitting the feedback to the transmitter node, receive a retransmission from the transmitter node, wherein the retransmission uses at least one retransmission parameter different from a corresponding parameter used for the data transmission.

17. An apparatus comprising:
a processing unit; and
a non-transitory memory including instructions that, when executed by the processing unit, cause the apparatus to:
send a data transmission to a receiver node, the data transmission including one or more code blocks and transmission of an associated reference signal;
receive, from the receiver node, feedback indicating a transmission-specific channel quality indicator (CQI) associated with the received data transmission; and
send a retransmission to the receiver node, using retransmission parameters determined based on the received feedback.

18. The apparatus of claim 17, wherein the feedback indicating the transmission-specific CQI represents a negative acknowledgement (NACK) indicating decoding of the one or more code blocks at the receiver node was not successful.

19. The apparatus of claim 17, wherein the instructions further cause the apparatus to determine at least one retransmission parameter, the at least one retransmission parameter being one of:
a retransmission rate;
a modulation and coding scheme (MCS);
a power level;
a beamforming parameter;
a number of retransmitted code blocks; or
a number of check blocks.

20. The apparatus of claim 17, wherein the transmission-specific CQI corresponds to a suggested retransmission rate, and wherein the retransmission is performed using the suggested retransmission rate.
